(19) United States
(12) Patent Application Publication
(10) Pub. No.: US 2016/0132946 A1
(43) Pub. Date: May 12, 2016

(54) SYSTEM AND METHOD FOR IDENTIFYING QUALIFIED PARTIES TO A TRANSACTION

(71) Applicant: SafelyStay, Inc., Atlanta, GA (US)

(72) Inventors: Andrew Bate, Atlanta, GA (US); Stuart Bate, Atlanta, GA (US); Pranav Patel, Albuquerque, NM (US); Lui King, Atlanta, GA (US)

(21) Appl. No.: 14/535,863

(22) Filed: Nov. 7, 2014

(51) Int. Cl. G06Q 30/06

(52) U.S. Cl. CPC G06Q 30/0609

(57) ABSTRACT

A system and method for identifying and verifying qualified parties to a transaction. In an aspect, the present invention can be configured to verify a party as a qualified party based upon verified information. In an aspect, the present invention can be used to configure transaction options such that the buyer and seller will have either reduced incentive for fraud or protection from fraud from the other party.

### BACKGROUND OF THE INVENTION

1. Technical Field

The present invention is in the technical field of verifying parties to a transaction.

2. Related Art

In today's information age, products and services are offered to individuals and entities through various different means, including the internet. Individuals can secure reservations at private homes for overnight stays, can schedule individuals and companies to perform services at their homes, and buy or rent products from entities or individuals. However, given these transactions occur over the internet, many of these transactions are done blindly by both parties. For example, a person reserving a room or house from a private property owner does not know for sure whether or not the property is in favorable conditions. Likewise, the renter of the property does not know if the person renting the property is a good guest or a person with questionable behavior that has a history of damaging property. The same scenario is applicable for services provided online.

In such situations, the transaction participants are unknown to each other, which can carry risks for both a “buyer” and a “seller,” especially when neither party is associated with a name brand (e.g., The Four Seasons or the like). These risks keep possible participants, both “buyers” and “sellers”, from joining a market place and force those who do join to accept the possibility of being victims of fraud.

Fraud from the “seller” is quite commonplace. Common rental fraud schemes include duplicating an actual rental listing that is for rent, creating fictitious listings that are for rent, misrepresenting the condition of a listing, offering a real but unavailable property, renting out a home that is currently in some state of foreclosure, or renting out a home that will be sold soon.

Service providers similarly can attempt to sell services they're not accredited, licensed, or insured to provide. For example, a person claiming to be an electrician who isn't licensed or insured should not be allowed to provide service as an electrician without disclosing that information. Likewise, babysitters providing services for childcare may not be desirable employees in the event that they have a criminal history for child abuse.

Fraud from a “buyer” is also commonplace: buyers may misrepresent their current level of funds, their intent with a transaction, or may be using this transaction as a lure to capture a victim. Depending on the payment arrangements, a buyer can receive some of the goods or services from a transaction and fall short on their financial obligations. Buyers may also misrepresent their use of a particular transaction. For example, a teenager may pose as a parent looking for a quiet weekend to rent a vacation home and really intend to host a wild party for his friends. Posing as other parties in a transaction could also result in sales of goods or services that the real buyer may not be authorized to purchase. For example, minors purchasing alcohol or other age-determinative goods over the Internet.

In addition, the buyers and sellers have to take the other person at their word based upon the information that the buyers and sellers have provided. While background checks can be performed, such options take time and are burdensome. Further, in today's technology driven world, transactions (e.g., securing reservations, scheduling a service provider, etc.) are expected to occur instantly over the internet, otherwise the parties will look elsewhere for the providing of services.

Therefore, there is a need for a system and method to ensure that both a seller and a buyer of a good or service can trust the other party on the end of the transaction. If trust is not possible in such a transaction, there is a need to still allow both parties to be supervised with options for recourse in case either party is not fulfilling their part of the transaction. There is also a need for the system to ensure the trust and allow the transaction to happen almost immediately.

### SUMMARY OF INVENTION

The present invention is a system and method for identifying compatible parties to a transaction. In an aspect, the present invention can be configured to identify a party as a compatible party based upon information provided by the party. In another aspect, the present invention can verify information from a verified source from the information supplied by the party. In an aspect, the present invention can be used to configure transaction options such that the buyer and seller will have either reduced incentive for fraud or protection from fraud from the other party.

These and other objects and advantages of the invention will become apparent from the following detailed description of the preferred embodiment of the invention.

Both the foregoing general description and the following detailed description are exemplary and explanatory only and are intended to provide further explanation of the invention as claimed. The accompanying drawings are included to provide a further understanding of the invention and are incorporated in and constitute part of this specification, illustrate several embodiments of the invention, and together with the description serve to explain the principles of the invention.

### BRIEF DESCRIPTION OF THE DRAWINGS

FIG. 1 is a schematic representation of a transaction verification system according to an aspect of the present invention.

FIG. 2 is a schematic representation of components of the transaction verification system of FIG. 1 according to an aspect of the present invention.

FIG. 3 is a schematic representation of a data structure utilized by the transaction verification system according to an aspect.

FIG. 4 is a schematic representation of a data structure utilized by the transaction verification system according to an aspect of the present invention.

FIG. 5 is a schematic representation of a data structure utilized by the transaction verification system according to an aspect of the present invention.

FIG. 6 is a flow diagram of a method performed by the transaction verification system according to an aspect of the present invention.

FIG. 7 a schematic representation of a data structure utilized by the transaction verification system according to an aspect of the present invention.

FIG. 8 is a flow diagram of a method performed by the transaction verification system according to an aspect of the present invention.

FIG. 9 is a flow diagram of a method performed by the transaction verification system according to an aspect of the present invention.

FIG. 10 is a flow diagram of a method performed by the transaction verification system according to an aspect of the present invention.

FIG. 11 is a flow diagram of a method performed by the transaction verification system according to an aspect of the present invention.

FIG. 12 is a schematic representation of a data structure utilized by the transaction verification system according to an aspect of the present invention.

FIGS. 13A and B are schematic representations of calls utilized by the transaction verification system to provide and fill data structures according to an aspect of the present invention.

FIGS. 14A-B of calls utilized by the transaction verification system to provide and fill data structures according to an aspect of the present invention.

FIG. 15 a schematic representation of a data structure utilized by the transaction verification system according to an aspect of the present invention.

FIG. 16 is a flow diagram of a method performed by the transaction verification system according to an aspect of the present invention.

FIG. 17 is a flow diagram of a method performed by the transaction verification system according to an aspect of the present invention.

FIG. 18 is a schematic representation of a data structure utilized by the transaction verification system according to an aspect of the present invention.

FIG. 19 is a flow diagram of a method performed by the transaction verification system according to an aspect of the present invention.

FIG. 20 is a flow diagram of a method performed by the transaction verification system according to an aspect of the present invention.

FIG. 21 is a flow diagram of a method performed by the transaction verification system according to an aspect of the present invention.

FIG. 22 is a flow diagram of a method performed by the transaction verification system according to an aspect of the present invention.

FIG. 23 is a flow diagram of a method performed by the transaction verification system according to an aspect of the present invention.

FIG. 24 is a schematic representation of a data structure utilized by the transaction verification system according to an aspect of the present invention.

### DETAILED DESCRIPTION OF THE EMBODIMENTS

The present invention will now be described more fully hereinafter with reference to the accompanying drawings, which are intended to be read in conjunction with this detailed description, the summary, and any preferred and/or particular embodiments specifically discussed or otherwise disclosed. This invention may, however, be embodied in many different forms and should not be construed as limited to the embodiments set forth herein. Instead, these embodiments are provided by way of illustration only and so that this disclosure will be thorough, complete and will fully convey the full scope of the invention to those skilled in the art.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc., of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. In an aspect, the methods and systems may take the form of hardware configured to perform specific steps (e.g., a DSP). More particularly, the present methods and systems may take the form of web-implemented computer software. In addition, the present methods and systems may be implemented by centrally located servers, remote located servers, or cloud services. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, computers and components found in cloud services, or other programmable data processing apparatus to produce a machine, such that the instructions which execute on the computer or other programmable data processing apparatus create a means for implementing the functions specified in the flowchart block or blocks. In an aspect, the computer program instructions may be loaded on a special purpose computer or server to carry out the functions and methods described below.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The methods and systems that have been introduced above, and discussed in further detail below, have been and will be described as comprised of units. One skilled in the art will appreciate that the units are a functional description and that the respective functions can be performed by software, hardware, or a combination of software and hardware. In one exemplary aspect, the units can comprise a computer. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

In an aspect, the present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, cloud services, mobile devices (e.g., smart phones, tablets, and the like) and multiprocessor systems. Additional examples comprise set top boxes, programmable consumer electronics, network PCs, minicomputers, mainframe computers, enterprise servers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc., that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

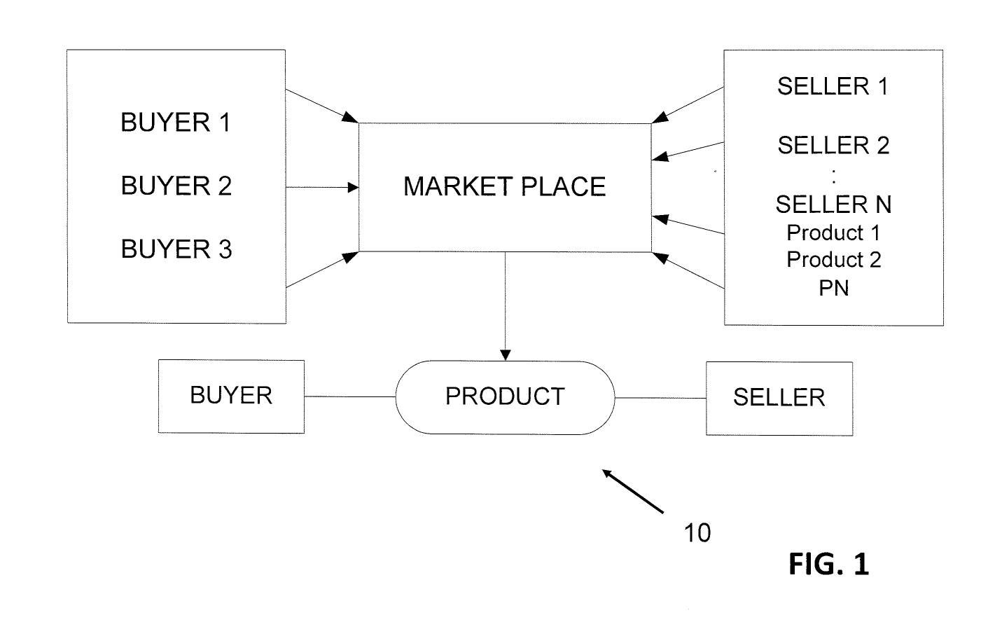

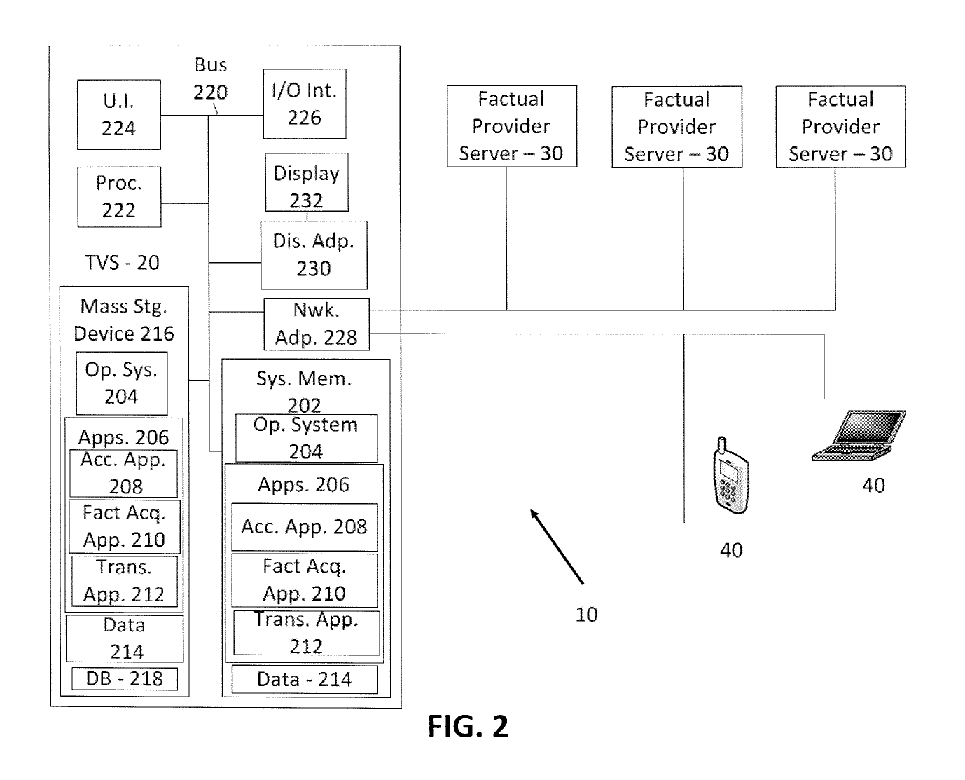

FIGS. 1-2 illustrate a transaction verification system 10 according to an aspect of the present invention. As shown in FIG. 1, the transaction verification system 10 is configured to facilitate the buying and selling of products, including both merchandise and services, provided in a market place in a manner that limits the buyers and sellers to a subset of people that both parties to the transaction (i.e., the buyer and the seller) deem as qualified and/or compatible to partake in the transaction. In an exemplary aspect, the transaction verification system 10 can be configured to allow each buyer or seller to set forth requirements to find a compatible participant to a transaction. In an aspect, the transaction verification system 10 is further configured to maintain accounts for multiple buyers and sellers. In an aspect, the transaction verification system 10 is configured to verify associated information for each of the buyers and sellers, discussed in more detail below.

As illustrated in FIG. 2, the transaction verification system 10 includes a transaction verification server (TVS) 20. In an aspect, the transaction verification server 20 can be configured to assist with transactions across multiple marketplaces, as shown in FIG. 1. In an aspect, the transaction verification server 20 is further configured to maintain accounts for multiple buyers and sellers. In an aspect, the transaction verification server 20 is configured to verify associated information for each of the buyers and sellers, discussed in more detail below. In an aspect, the transaction verification server 20 is further configured to communicate with factual provider servers 30. The transaction verification server 20 can be configured to communicate with multiple network devices 40 of the various buyers and sellers associated with the transaction verification system 10. In an aspect, the transaction verification server, 20, the factual provider servers 30, and network devices 40 are configured to communicate over the internet. In other aspects, the transaction verification server, 20, the factual provider servers 30, and network devices 40 can also be configured to communicate over a variety of networks, including, but not limited to, the internet, a local area networks, and the like. These and other aspects of the present invention are discussed in more detail below.

As shown in FIG. 2, the transaction verification server 20 of the transaction verification system 10 may have several applications (Apps.) 206, including, but not limited to, an account application (Acc. App.) 208, a fact acquirer application (Fact Acq. App.) 210, and a transaction application (Trans. App.) 212. These applications 206 are discussed in more detail below. In general, the applications 206 may utilize elements and/or modules of several nodes or servers. In any event, the transaction verification server 20 should be construed as inclusive of multiple modules, software applications, servers and other components that are separate from the network devices 40 and factual provider servers 30. In an aspect, the transaction verification server 20 can be configured to be a specific purpose server 20 to carry out the functions discussed in more detail below.

Referring to FIG. 2, the transaction verification server 20 can include system memory (Sys. Mem.) 202, which stores the operating system (Op. System) 204 and various applications 206. The transaction verification server 20 may also include data 214 that is accessible by the applications 206. The transaction verification server 20 may include a mass storage device (Mass Stg. Device) 216. The mass storage device 216 can be used for storing computer code, computer readable instructions, program modules, various databases (DB) 218, and other data for the transaction verification server 20. The mass storage device 216 can be used to back up or alternatively to run the operating system 204 and/or other applications 206, including the account application 208, the fact acquirer application 210, and the transaction application 212. The mass storage device 216 may include a hard disk, various magnetic storage devices such as magnetic cassettes or disks, solid state-flash drives, CD-ROM, DVDs or other optical storage, random access memories, and the like.

The transaction verification server 20 may include a system bus 220 that connects various components of the transaction verification server 20 to the system memory 202 and to the mass storage device 216, as well as to each other. In an aspect, the mass storage device 216 can be contained within the transaction verification server 20. In another aspect, the mass storage device 216 can comprise multiple mass storage devices 216 that are found separate from the transaction verification server 20. However, in such aspects the transaction verification server 20 can be provided access.

Other components of the transaction verification server 20 may include one or more processors or processing units (Proc.) 222, a user interface (U.I.) 224, an input/output interface (I/O Int.) 226, and a network adapter (Nwk. Adp.) 228 that is configured to communicate with other devices, including, but not limited to, the factual provider servers 30, the various network devices 40, and the like. The network adapter 228 can communicate over various networks. In addition, the transaction verification server 20 may include a display adapter 230 that communicates with a display device 232, such as a computer monitor and other devices that present images and text in various formats. A user can interact with the transaction verification server 20 through one or more input devices (not shown), which include, but are not limited to, a keyboard, a mouse, a touch-screen, a microphone, a scanner, a joystick, and the like, via the user interface 224.

In an aspect, certain functions and programs performed by the transaction verification server 20, and discussed in more detail below, can be accessed remotely via the network adapter 228. In an aspect, the transaction verification server 20 can be configured to allow access to the programs via various known secured methods. For example, verified users of the other servers 30 and network devices 40 with the correct login credentials may be able to access the transaction verification server 20.

In an aspect, the account application 208 of the transaction verification server 20 is configured to create, manage, and maintain accounts for entities utilizing the transaction verification system 10. In an aspect, the account application 208 can be configured to generate, verify, and maintain profiles associated with an entity. In an exemplary aspect, the profiles generated, verified, and maintained by the account application 208 can include profiles associated with sellers, buyers, and products. As discussed in more detail below, the products can comprise merchandise and services.

In an aspect, the accounts can represent an online persona of a person or entity. In an aspect, a person/entity can have multiple accounts. For example, an individual can represent themselves as an individual, an organization, or a company. The same can be applicable to entities as well. In an exemplary aspect, a user can make separate accounts in order to differ between access through APIs and through a remote access option, including, but not limited to, web access.

In an aspect, the account application 208 is configured to create a person profile/record specific to the individual/entity. In an aspect, the account application 208 is configured to take information provided by the individual and call on other applications 206, including the fact acquirer application 210, of the transaction verification server 20 to verify and gather additional information. In an exemplary aspect, the account application 208 manages a separate profile for each entity a particular user would represent such as a business, business division, business job title, organization, individual, or family.

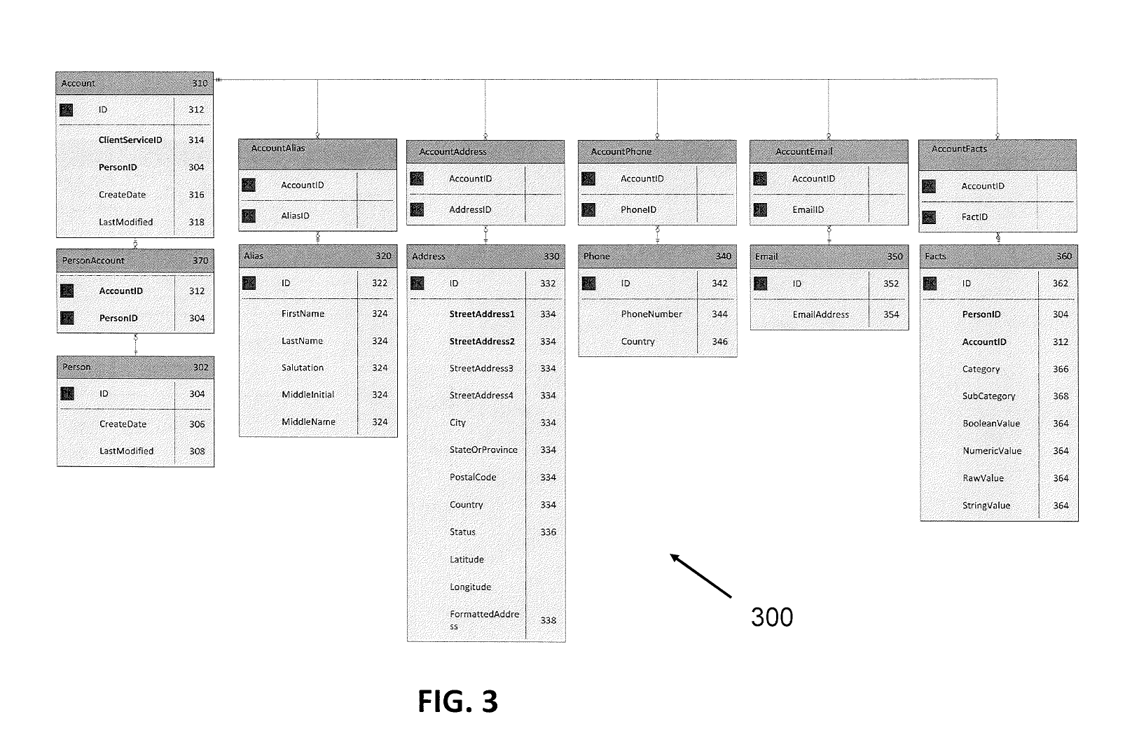

FIG. 3 illustrates data structure representative form of an entry 300 for an individual with one or more accounts according to an aspect of the present invention. As discussed above, the transaction verification system 10 can utilize multiple databases. FIG. 3 illustrates a conceptual database schema depicting the main data entities required to represent accounts and the relationship of data entries needed for the transaction verification system 10. Lines indicate the relationship between data entries and their cardinality. In an exemplary aspect, multiple accounts relate to one person. In such an exemplary aspect, each detail about the person can be identified as valid for a specific profile, allowing a person to act on behalf of different entities using different sets of data for each transaction.

As shown, the individual has a person record 302. The person record 302 is used to identify a single person. As stated above, a single person can have multiple accounts within the transaction verification system 10, but it is beneficial to have a person record 302 in order to share common information across such accounts. A person account record 370 includes information that relates a specific account with a person record 302, as shown in FIG. 3. The person record 302 also includes a person ID 304 associated with the person in the person record 302. The person ID 304 is utilized to identify an individual across all potential accounts, as shown in the person account record 370, that the individual generates and maintains within the transaction verification system 10. In an aspect, the account application 208 can generate the person ID 304 when the person first accesses the system 10 in order to create an account. In other aspects, the person ID 304 can be supplied by the person. For example, the person could supply their social security number or a driver license's number as the person ID 304. In other aspects, the person ID 304 can also be a user generated login name or the like. In addition, the person field 302 can also include time stamp information, including the create date 306 as to when the account application 208 created the person ID 304, as well as a last modified entry 308, which keeps track of the last time any information associated with the person was last modified.

Similar to the person field 302, the account application 208 also manages an account record 310. The account record 310 includes an account ID 312 to identify an individual account. In addition, the account field 310 can include a client service ID 314 that relates the account to a specific service in case there are multiple services available (e.g., indicating that the account is only valid for a specific service), the person ID 304 of the person who created the account (i.e., the account associated with the account ID 312), a CreateDate 316 and a LastModified 318 entry. In an aspect, additional information can be included. For each person record 302, the account application 208 can require additional information, including, but not limited to, a person alias record 320, an account person address record 330, a person phone record 340, a person email record 350, and a person facts record 360. Each of these additional pieces of information can also be tied to a profile, to show that this piece of information is useful in a given context for the person record 302. For example, when a person is making transaction on behalf of their family, the home address and phone number of the family/person should be used. In another aspect, when a person is making transactions on behalf of a company for which he or she is employed, the home address and phone number of the employee may not be the desirable contact information.

In an aspect, the person alias record 320 is utilized to keep track of the name associated with the account. For example, if the person associated with the person alias record 320 is to be used by the individual as his or her own personal account, the person alias record 320 would contain information about the individual, including the full name of the person. In the case of the account being associated with a corporation or the like, the information in the person alias record 320 can contain the official business name of the corporation, as well as other known names for which the corporation or business entity is known or doing business under a certain name. In an aspect, the person alias record 320 can include an alias ID 322, and name entries 324, which, as shown in FIG. 3, include entries for the parts of the full name of an individual, as well as a salutation.

FIG. 3 further illustrates an address record 330, utilized to keep track of the address of the entity associated with the person record 302. The address record 330 can include an address ID 332 and address entries 334, which can include, but are not limited to, various inputs for the street address (e.g., 123 Apple St, Suite 10), city, state or province, postal code, country, GPS coordinates (e.g., longitude and latitude), and the like. In addition, the address record 330 can include a status entry 336 and a formatted address 338, which can include, but is not limited to, a country specific representation formatting of the address data. In addition, phone records 340 can be associated with the person record 302. In an aspect, no phone records 340 or multiple phone records 340 can be associated with a person account 302. In an aspect, the phone record 340 can include a phone ID 342, a phone number 344, and a country 346 associated with the phone number 344. Likewise, a wide range (e.g., zero to many) email records 350 (with an email ID 352 and an email address 354) can be associated with the account record 310 as well.

In addition, the person record 302 can be associated with zero to a plurality of facts records 360. In an aspect, the facts record 360 can include a wide variety and types of facts that are associated with the person record 302. In an exemplary aspect, the facts record 360 can include a facts ID 362 identifying the facts record 360. In addition, the facts record 360 can include the person ID 304 and account ID 312 in order to associate the correct person and facts with the person record 302 and account record 310. In addition, the facts record 360 can include numerous other fact entries 364. The fact entries 364 can be directed to all types of information that could be associated with an account, such as, but not limited to, bank account information, account balance, shipping restrictions, criminal records, ratings, buyer requirements, seller requirements, preferences, feedback from previous transactions, historical browsing history, past purchase data, group and organization membership history, personal relationship graph data, legal documents associated with the account, policies associated with the account, travel history, physical characteristics, medical history, and the like. In addition, the fact entries 364 can take the form of different values to convey information. For example, the facts value can include, but are not limited to, Boolean values, numeric values, raw values, string values, ranges of values, serialized objects, lists of values, encoded strings, data representing conditional logic, and the like. In addition, the fact record 360 can also include category 366 and subcategory 368 entries, discussed in more detail below. In addition, the accounts application 208 can also generate a person accounts record 370 that keeps track of the accounts associated with an individual. In an exemplary aspect, the person accounts record 370 can include the person ID 302 and all of the account IDs 312 that are associated with the individual.

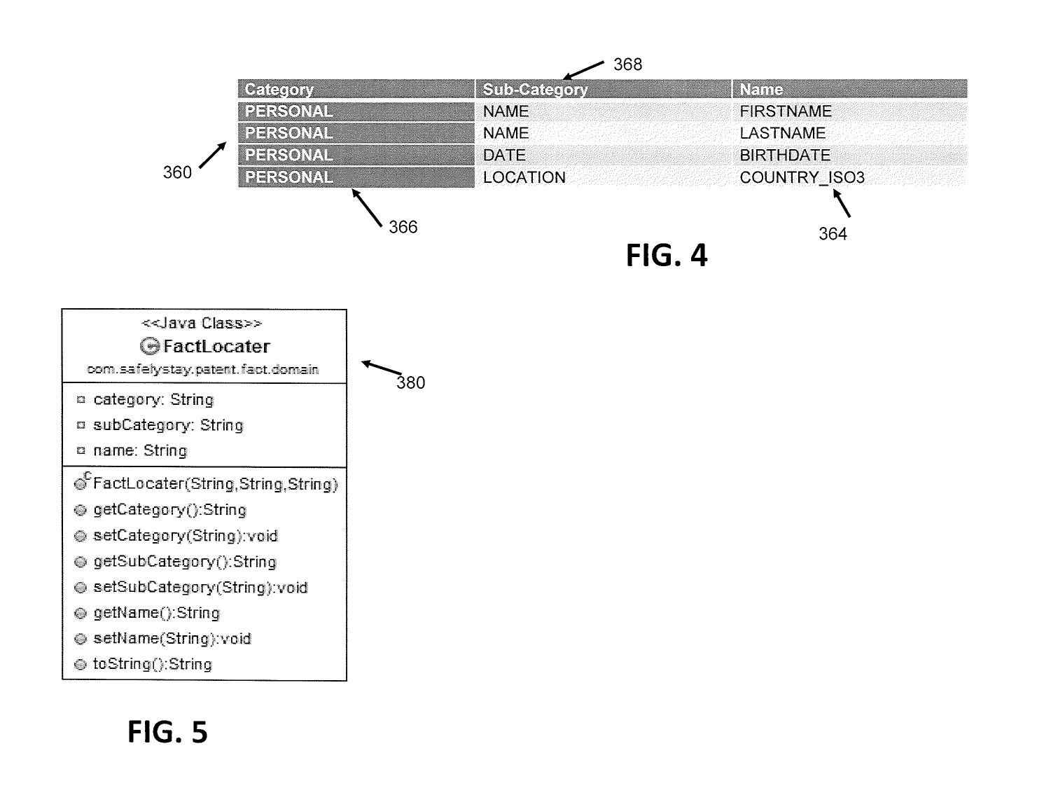

As shown in FIG. 3, the records that are generated concern facts and information associated with a person. The facts that are received from the person creating an account need to be checked against verified information, discussed in more detail below. Therefore, there is a need to associate the facts received from the person with facts provided by outside fact providers, as well as being able to identify individual facts. In an aspect, in order to meet this operational need, facts can be classified by a category (366), subcategory (368), and name (364). FIG. 4 illustrates an example of types of facts 360, with their categories 366, sub-categories 368, and names of the facts 364, and FIG. 5 illustrates fact locaters 380 used to provide a unique identity for a specific fact in a specific context, according to an aspect.

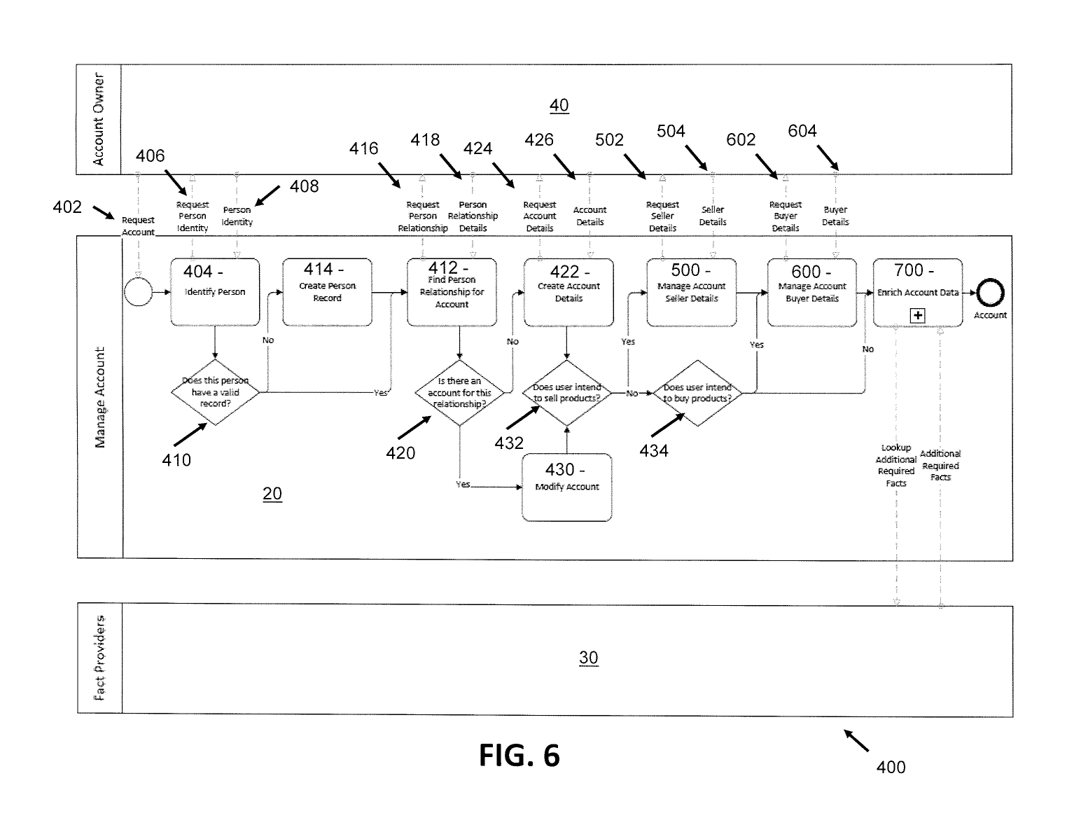

In an aspect, a fact locater 380 categorizes and associate facts 360 with values (364, 366, 368 as shown in FIGS. 3 and 4). Facts 360 are configured to be able to represent data in all types and formats. In an exemplary aspect, in this case for ease of implementation, the facts 360 can be limited to numbers or words. The “type” attribute stores which type of information is stored in the fact 360. Facts can also expire, for example, items like criminal records, credit ratings, etc. and/or can change over time. As the facts are created, policies are set for each fact. In an aspect, policies are dependent on the specific implementation of the fact provider 30. When a fact is gathered from the fact provider 30, the policy determines when the fact 360 will expire. Facts 360 can also have been entered but not yet validated, as shown in FIG. 6. An example of this is an email address. Someone can enter an email address, it can be a valid email address, but in that case it can't be valid for an account until someone has proven they have access to the email account. A fact 360 that has not yet been validated is treated differently than a fact 360 that has been validated.

FIG. 6 illustrates a method (400) of managing, including the creating and/or updating of, an account by the accounts application 208 and other components of the transaction verification system 10 according to an aspect. To initiate the management of an account, the transaction verification server 20 will receive a request from a user/account owner (via the network device 40) to access an account (step 402). In an aspect, the request can take the form of an individual accessing at a registration screen associated with the transaction verification server 20. The request can include a request to set up an initial account associated with the user/account owner 40, set up an additional account for the user, or access an already established account. Upon receiving the request (step 402), the accounts application 208 of the system 10 will then identify the individual (step 404). In an aspect, to identify the individual, the accounts application 208 will request the individual, via the network device 40, to provide person identification information related to the individual person associated with the desired account (step 406). In an aspect, the request can be in the form of a login-in screen that requires a username and password, or some other identification verification means such as a multi-factor authentication device, a plurality of questions with answers only the individual associated with the account would know, facial recognition technology and other forms of biometric security, and the like. In an aspect, the accounts application 208 can just request information that will identify an individual, such as, but not limited to, a social security number or other form of identifier. In an aspect, steps 402, 404, and 406 can be performed in one action by providing a login interface associated with the transaction verification system 10.

After requesting the information (step 406), the accounts application 208 is configured to receive the person identification information from the network device 40 (step 408). Upon receipt of the person identification information, the accounts application 208 will then see if there is a valid person record within the system 10 (step 410). In an exemplary aspect, the accounts application 208 will search person records 302 on the transaction verification server 20 (e.g., those records 300 stored in the databases) to see if any match the person identification information supplied by the user. When a matching person record 302 is found, the accounts application 208 will then turn to finding an account relating to the individual for which the person wants to access (step 412), discussed below. If no matching person record 302 is found, the accounts application 208 can generate a new person record 302 (step 414) before finding the related account(s) (step 412), essentially creating a new account for the person.

To find an appropriate profile, the accounts application 208 will request the user to provide information that identifies the profile the individual plans to use for the session (step 416). In an exemplary aspect, the request can include providing a list of account profiles (e.g., the person relationship as shown in FIG. 6) associated with the person record 302 from which the user can select the desired account. In other aspects, the request can be in the form of questions that ask for specific information that identifies the account or can include multifactor authentication data, including, but not limited to, an authenticator, geo-location for contextual reference, and the like. After the request, the accounts application 208 is configured to receive account identifying information (step 418) (e.g., the selection of the person relationship details as shown in FIG. 6). In an exemplary aspect, a user could receive a web page comprising recent transactions for the account profile, or a set of product catalogs that are preconfigured to work with the chosen account profile. In an aspect, the account profile 310 identifying information that is received by the accounts application 208 (i.e., that is supplied by the user) can include, but is not limited to, an account identifier (e.g., the account II) 312), the alias of the account (e.g., information found in the alias record 320), address information (e.g., information found in the address record 330), phone number (e.g., phone number 344 from phone record 340), email address (e.g., email address 354 from email record 350), geo-location coordinates, IP address information, specific device information, and other relevant facts (facts 364 from the fact record 360).

Upon receipt of the account identifying information (step 418), the accounts application 208 will then determine whether or not the information received corresponds to an existing profile (step 420). In an exemplary aspect, the accounts application 208 will take the received information and compare it to information stored within a person record 302, as well as other records (320, 330, 340, 350, 360) associated with the account record 310. If the accounts application 208 finds an existing account (e.g., person record 302, account record 310) that matches the information, the accounts application 208 will then proceed to the management/modification of the account (step 430), discussed in more detail below.

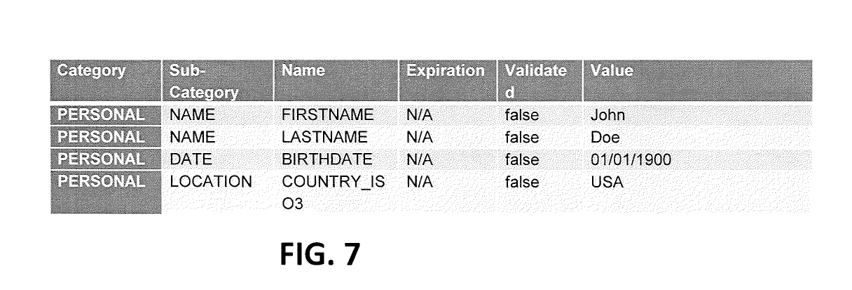

If the accounts application 208 fails to find a corresponding account, the accounts application 208 can then create a new account (step 422). In an aspect, the accounts application 208 can create a new account by generating a new accounts record 310, as well as the other corresponding records (320, 330, 340, 350, 360). In an exemplary aspect, the accounts application 208 can begin by generating a new accounts record 310 and associated records from the accounts information already received in step 418. In an aspect, the accounts application 208 can request additional accounts information from the user (step 424), and receive account information from the user (step 426) in order to generate a new account (step 422). In an exemplary aspect, the accounts application 208 can take the information already supplied from step 418, as well as the person identifying information from step 408, to search already established records (302, 310, 320, 330, 340, 350, 360) for additional information to generate the new accounts record 310 and associated records. In an exemplary aspect, data already established in the records (302, 310, 320, 330, 340, 350, 360) and information supplied in step 418 can be sent to fact providers to look for relationships between existing data sets or validate new data. FIG. 7 illustrates a new account record 310 generated from method 400, according to an aspect.

Once an account has been created (step 422), or the user has selected an account and account profile 310 to modify (step 430), the accounts application 208 can then prompt the user as to whether or not to sell a product (i.e., services and/or merchandise) (step 432) and/or buy a product (step 434). Choosing to sell a product will prompt the accounts application 208 to perform the management of a seller's account (step 500), whereas the selection to buy a product will prompt the accounts application to manage a buyer's account (step 600), both discussed in more detail below. Once the accounts application 208 has received the input from the user and completed either or both of these steps, the accounts application 208 can call on the fact acquirer application 210 to enrich the data for each account (step 700), discussed in more detail below.

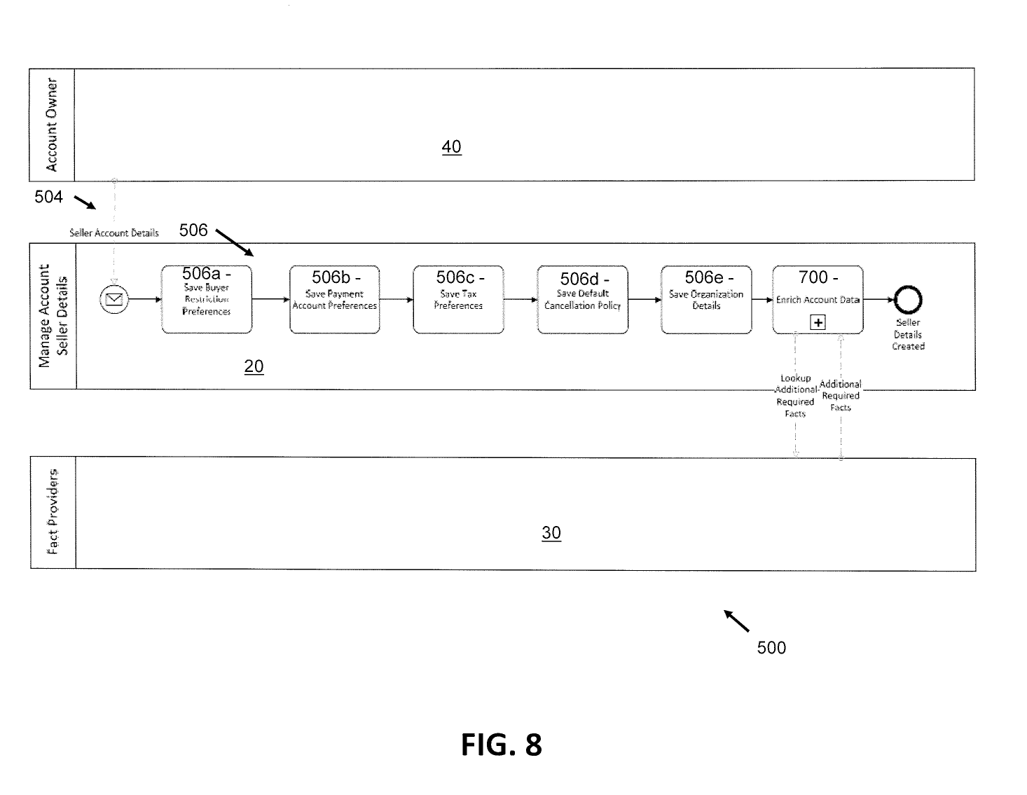

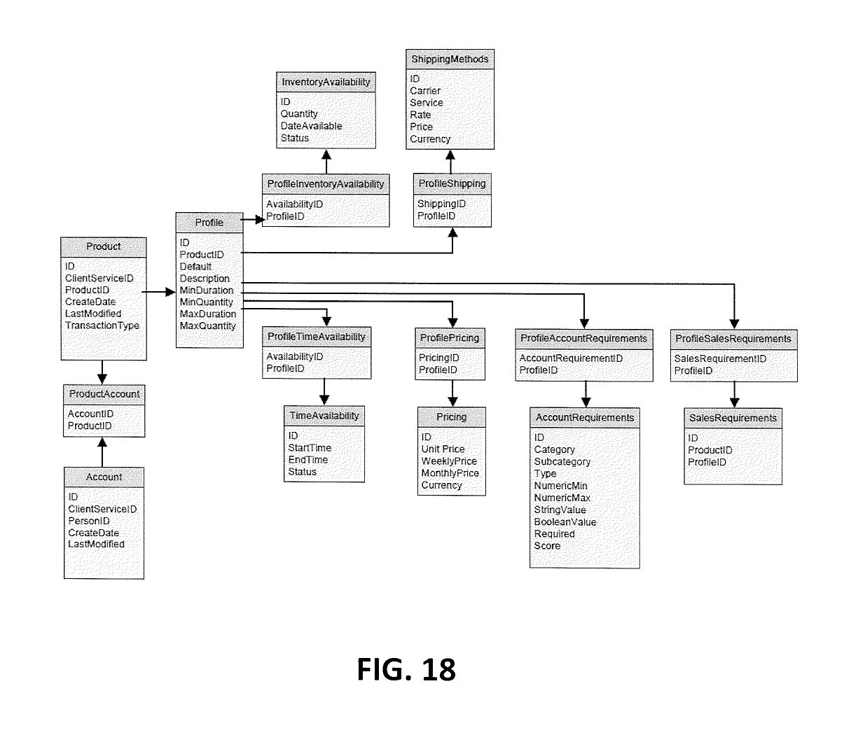

FIGS. 6 and 8 illustrate the accounts application 208 managing a seller account (method 500) according to an aspect. If the user selects an account to sell a product, the accounts application will request seller details from the user (step 502 (shown in FIG. 6)) (via the network device 40). In one aspect, the only details required may be to show that the account owner has interest in selling items. In another aspect, the seller may define overall aspects of his or her selling experience such as a store name, preferred channels of commerce, and the like. In an exemplary aspect, the accounts application 208 can prompt the user as to what information to supply by providing specific questions (e.g., in the form of text fields, select boxes, file uploads, checkbox forms, etc.). In another aspect, the user can provide the information desired. Such information can include, but is not limited to, restriction preferences, shipment methods, payment disbursement preferences, account preferences, sale tax preferences, organization details, preferred buyer facts (i.e., characteristics that the seller desires from buyers of the product, which as discussed above includes merchandise and services) and cancellation policies. In an exemplary aspect, the user will be required to provide information that cannot be a default value, which can include, but is not limited to, payment disbursement information, and the like. After prompting, the accounts application 208 is configured to receive the seller account information/details (step 504). Upon receiving the seller account information, the accounts application 208 can be configured to save the information into a product record through the account product records (step 506) (see FIG. 18). In an exemplary aspect, as illustrated in FIG. 7, the accounts application 208 can save buyer restriction preferences (step 506a), payment account preferences (step 506b), tax preferences (step 506c), default cancellation policy (step 506d), and organization details (step 506e) in order to gather details about the specific profile that the account owner wishes to set up. In an aspect, the information can apply to the seller's preferences that are applicable to all products and services supplied by the seller. Once the data from the user (step 504) has been saved (step 506), the accounts application can then enrich the account data (step 700), discussed below.

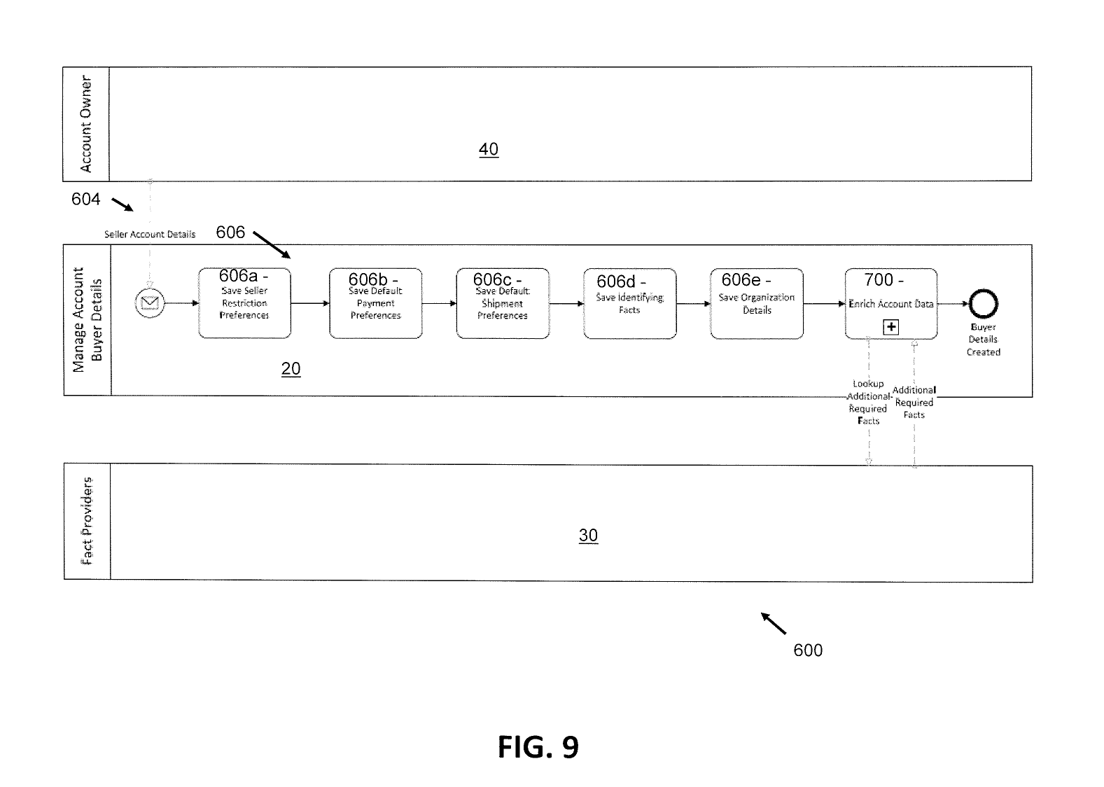

FIGS. 6 and 9 illustrate the accounts application 208 managing a buyer account (method 600) according to an aspect. If the user has determined to use an account to buy products, the accounts application 208 will request buyer details from the user (step 602 (shown in FIG. 6)) (via the network device 40). In an exemplary aspect, the accounts application 208 can prompt the user as to what information to supply by providing specific questions (e.g., in the form of text fields, select boxes, file uploads, checkbox forms, etc.). In another aspect, the user can provide the information desired. Such information can include, but is not limited to, restriction preferences, payment preferences, account preferences, organization details, preferred seller facts (i.e., characteristics that the buyer desires from sellers of the product or service), and shipping preferences.

After prompting, the accounts application 208 is configured to receive the buyer account information/details (step 604). Upon receiving the buyer account information, the accounts application 208 can be configured to save the information into the account records (step 606). In an exemplary aspect, as illustrated in FIG. 9, the accounts application 208 can save seller restriction preferences (step 606a), payment account preferences (step 606b), shipment preferences (step 606c), identifying facts (e.g., work phone number, shipping addresses and email addresses not previously shared, and other information not previously captured associated with the user, and the like) (step 606d), and organization details (step 606e). In an exemplary aspect, the seller can select restriction preferences (606a) that provide a factoring aspect, discussed in more detail below. When a seller has a greater risk of being fraudulent, the seller can configure the transaction to require greater funds from the transaction to be kept in escrow until the end of the transaction. In some instances of this exemplary aspect, some funds can be delivered to the seller before the end of the transaction.

In an aspect, the information can apply to the buyer's preferences that are applicable to all products wanted by the buyer for the current account profile 310. Once the data from the user (step 604) has been saved (step 606), the accounts application can then enrich the account data (step 700), discussed below. The establishment of the buyer profiles and the seller profiles helps ensure that the transaction verification system 10 can find compatible buyers and sellers.

As illustrated in FIGS. 8-9, the accounts application 208, with assistance from the facts acquirer application 210, can enrich the account data (step 700) according to an aspect. In an aspect, the enriching account data method 700 includes verifying that the account information given by the user in methods 300, 400, and 500 is valid. For example, a user may have provided a name, address, and birth date that can be verified with fact verifying providers (e.g., e-verifile). In another aspect, the enriching account data method can include gathering additional information about the account that wasn't supplied by the user. In another aspect, the accounts application 208 can take the information and provide it to the facts acquirer application 210 to see if the information provided identifies an individual that has undesirable characteristics. For example, the accounts application 208 can check whether the person is on a Terrorist Watch List, have outstanding warrants issued against him, poor performance in past transactions, scored poorly in past credit checks, and the like.

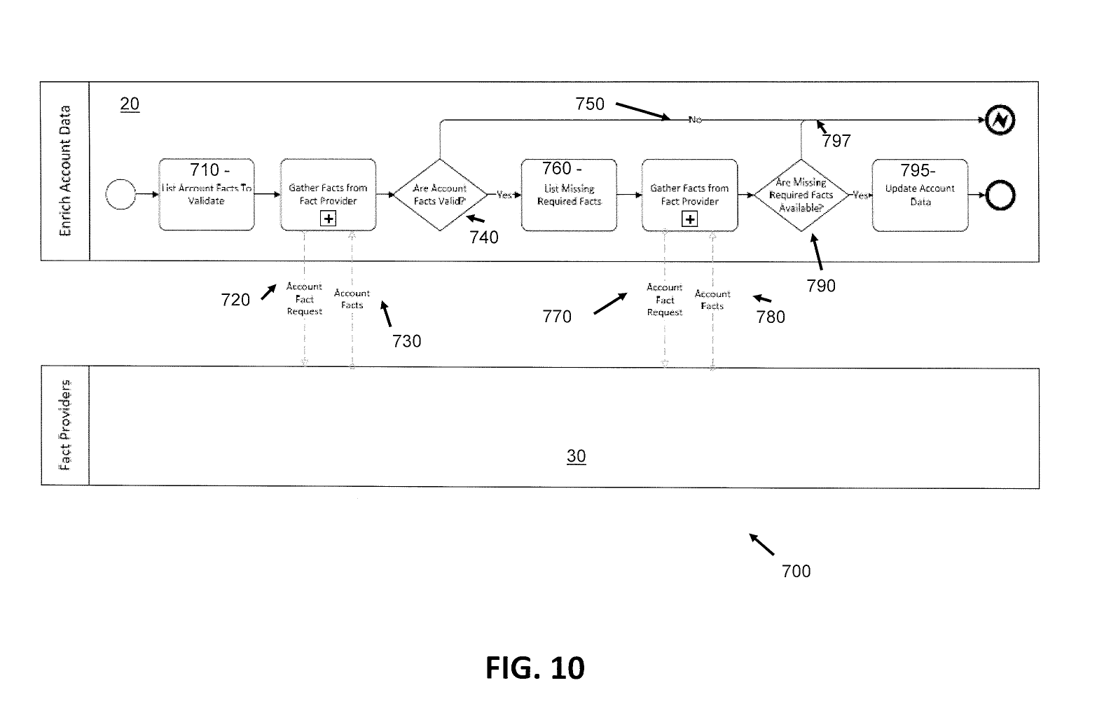

Referring to FIG. 10, the accounts application 208 will assemble a list of facts saved to the account to be verified (step 710). An administrator can set up the facts that need to be verified. In another aspect, the facts are information that can be validated. For example, most transactions wills require basic information to be verified, including, but not limited to, that the identified person on the other side of the transaction is associated/owns the information provided (phone number, address, email address, etc.). In an aspect, the needed facts are defined for a particular marketplace. For a vacation home rental market, the facts would include bad or a negative stay history, criminal history, terrorism history, et cetera for the potential renter (i.e., buyer).

Once the needed verified facts are gathered, the same facts are requested from fact providers 30 (step 720). In an aspect, a registry is created between the transaction verification server 20 and the fact providers 30 to insure integration between the two. In an exemplary aspect, the registry has input facts and output facts mapped to whatever format is needed to facilitate communication between the fact providers 30 and the transaction verification server 20. In an aspect, the registry can be hosted on the transaction verification server 20.

In an aspect, some of the facts (e.g., name, birthdate, and social security number) can be passed along to a fact provider 30 to identify the facts needed, discussed in more detail below in relation to FIGS. 13A-B. In an aspect, the accounts application 208, via the facts acquirer application 210, will receive the facts requested from the fact providers 30 (step 730). Once the requested verification facts have been received, the accounts application 208 will check to see if the account facts provided by the user are valid (step 740). In an aspect, the accounts application 208 will compare the facts directly against one another—if there is not a direct match for the verification facts, the accounts application will provide notice to the transaction verification server 20 (step 750). In an aspect, the transaction verification server 20 can be configured to terminate the connection with the user of the network device 40, and cancel out the account record being recorded. In another aspect, the information already supplied can be collected and kept on file by the transaction verification server 20 as a compromised account.

Returning to the verification comparison step (740), if the facts are verified, the accounts application 208 can further review the application to collect additional required facts (step 760). In an aspect, the facts can include, but are not limited to, an address, a personal identification number (e.g., Social Security Number (SSN), Driver's License, passport number, etc.), email, and the like. Upon assembling the needed facts (step 760), the accounts application 208 can then call on the facts acquirer application 210 to acquire additional facts from fact providers (step 770). For example, a SSN can be used to look up a person's criminal history. In an aspect, such additional facts can include, but are not limited to, criminal history, bad credit, bad stay history, and the like. The facts acquirer application 210 will then return the acquired facts from the facts provider (step 780). The accounts application 208 will then see if all the missing required facts have been returned (step 790). If all the facts are found, then the account records are updated (step 795). Otherwise, the accounts application 208 terminates the account (step 797).

In other aspects, the accounts application 208 can also request the user to update information before terminating the account (step 795). For example, a user may have entered in a false address by accident (e.g., address is 123 Maple St., user entered 213 Maple St.), the credit card saved previously has expired, or the criminal background check is no longer current. The accounts application can allow the user to correct and/or update such information (e.g., correct the address, provide a new credit card number, and authorize a new criminal background check).

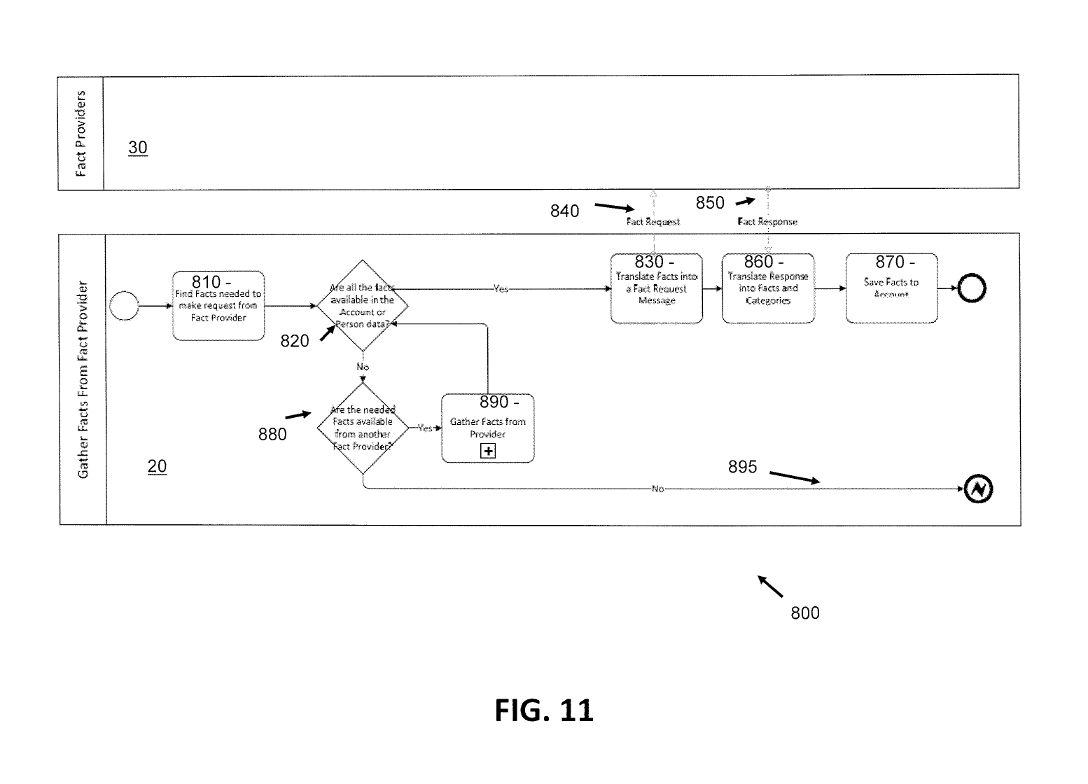

In an aspect, the accounts application 208 and the fact acquirer application 210 can be utilized to communicate with the fact providers 30 in order to ask for the facts and receive the facts from the fact providers (step 720, 730, 770, and 780). In an aspect, multiple fact providers 30 may need to be communicated with in order to gather the facts needed. In addition, the facts acquired from one fact provider 30 may be used to acquire additional facts from other fact providers 30. FIG. 11 illustrates such an aspect of acquiring needed facts from multiple fact providers 30 (method 800).

First, similar as to the steps of method 700 discussed above, the accounts application 208 will determine which facts are needed to be supplied in order to obtain additional information (step 810). Next, once the facts that are needed to be used to find additional information are identified, the accounts application 208 can then determine if the facts can be found within saved records (step 820). In an aspect, the information can be in the account records just created, or in related account records. In an aspect, the registry is configured to be aware of the facts needed. First registry identifies and acquires the facts already acquired. The registry can then continue to acquire other facts until a determination can be made. This can done recursively, as it could happen many times until the registry acquires all the data needed.

If the facts that are needed are found, the facts can be translated into a fact request message (step 830). The message can then be sent out to the fact provider (step 840). The fact provider 30 can provide the fact response (step 850), which can then be translated by the fact acquirer application 210 into facts for the records (step 860) and then saved to the accounts (step 870). If the facts that are needed to be provided to the fact providers 30 are not available (step 820), the accounts application 208 can call on the facts acquirer application 210 to acquire them (step 880), and then gather and assimilate the facts acquired from the provider (step 890). If the facts acquirer application 210 determines that the needed facts cannot be acquired from the facts provider (i.e., the facts providers 30 need a fact to provide a fact that is unavailable), then the transaction verification server 20 can be notified that there is a problem (step 895). In an aspect, the profiles/account records 310 will indicate when the absence of information will be a problem. For example, the profile 310 can be configured to match only with other individuals “without criminal records” or can be configured to not to allow a match with people with known criminal records. In one case is acceptable to not find the information, in the other case it is not.

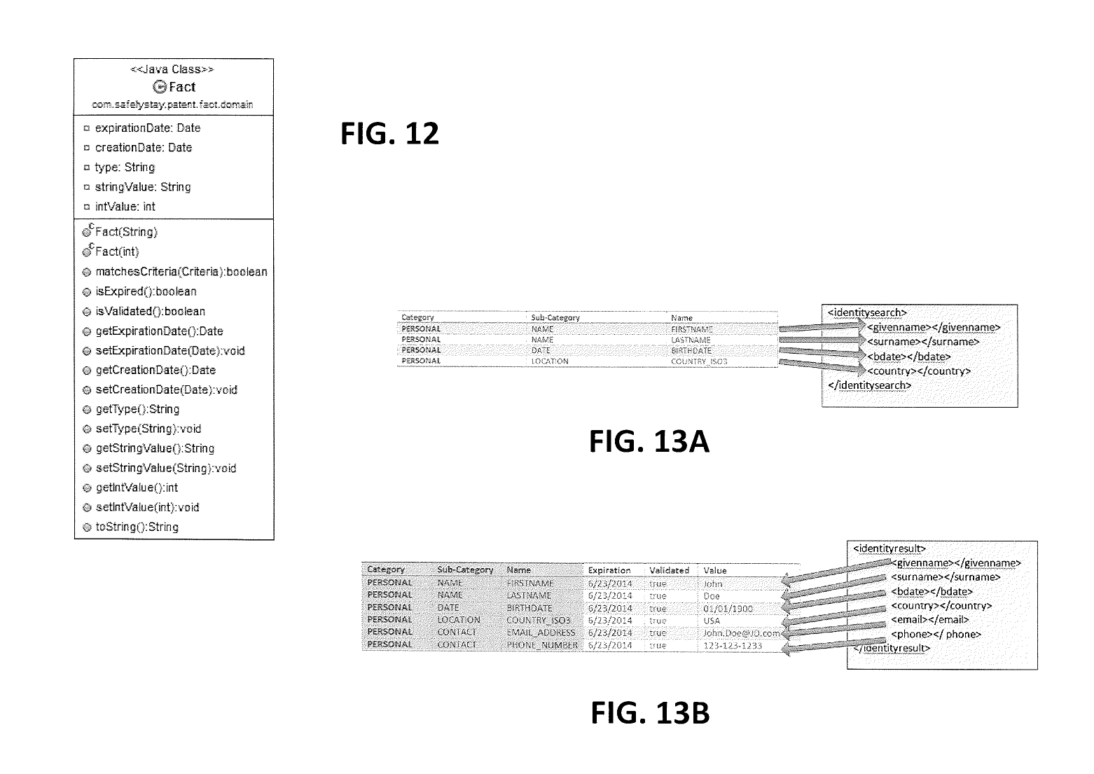

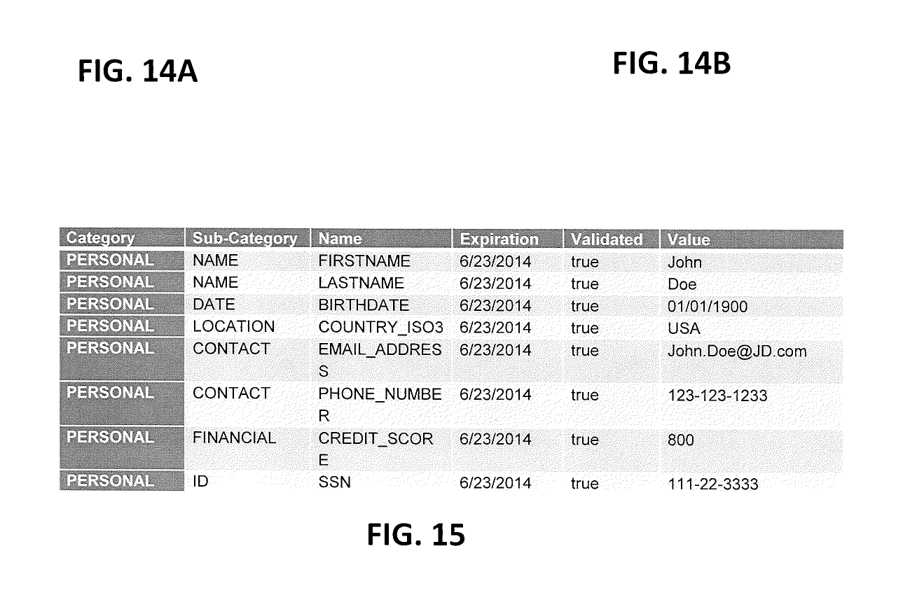

In an aspect, fact providers 30 are API Calls to external products and information services. This means there will be both an input and an output. Therefore, in an exemplary aspect, both the input values and the output values for the provider are abstracted into fact beaters to produce the facts. FIG. 12 provides an example of a fact produced from a fact locator (see FIG. 5) according to this aspect. The fact (i.e., the values that correspond to the categories from the fact locator) can be stored in a data object after being found by the fact locator, similar to the Java object illustrated in FIG. 12. When calling upon fact providers 30, the inquiry request (i.e., the API Call) must map the facts between the fact locators stored on the transaction verification server 20 and those of the fact providers 30 in order to request the information and receive the information. FIGS. 13A-B illustrate examples of a mapping used during an inquiry request (step 720 and/or 770) (as shown in FIG. 13A) and the response (step 730 and/or step 780)(as shown in FIG. 13B) according to an aspect. The mapping of messages to facts and fact locaters enables a common format for sharing information with unambiguous values for data. In an aspect, the mapping is done manually at the time the fact provider 30 is being registered. FIGS. 14A-B illustrate the request for and response to information used to provide information already acquired to obtain additional facts (shown in FIG. 15), as discussed in regards to method 800.

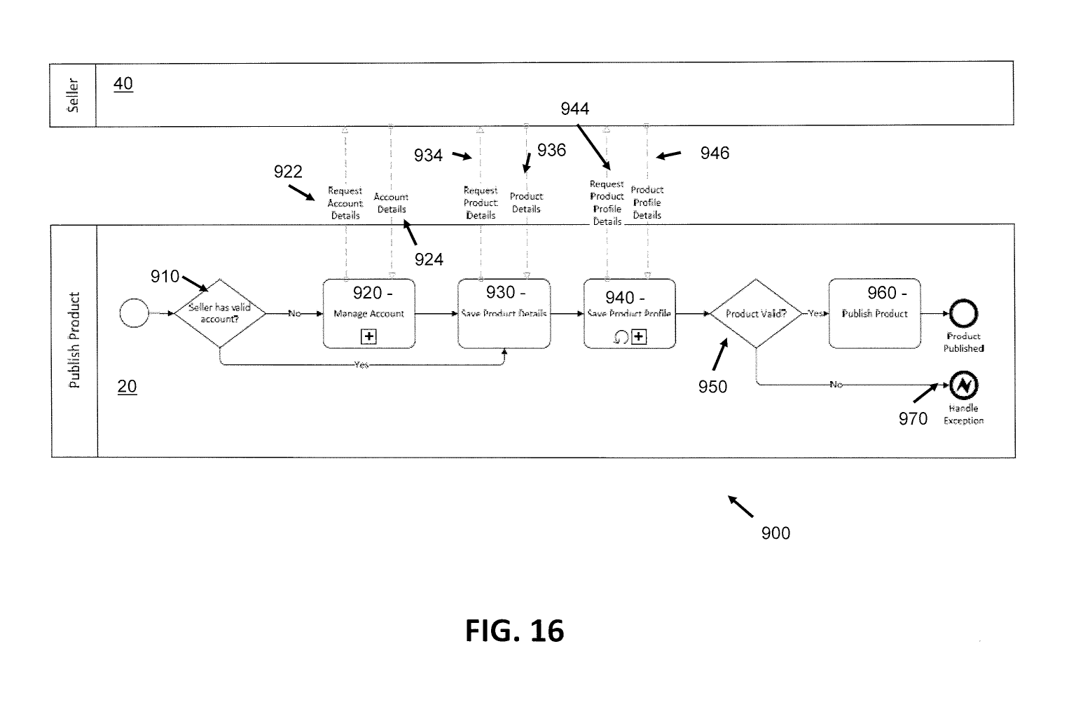

Returning to an account of a seller, a product needs to be associated with the account record. As discussed above, a product can include merchandise and/or services. FIG. 16 illustrates a method (900) of associating a product with an account of a seller according to an aspect. First, the accounts application 208 will verify that the seller has a valid account (step 910). If the seller does not have a valid account, the accounts application 208 will call upon the seller to manage the account (step 920), which is similar to the management of accounts discussed above, including requesting and receiving account details (steps 922 and 924 respectively). In an aspect, the account can be checked to be valid. In such aspects, once the account has been checked to be valid (either initially (step 910) or after managing the account (step 920)), the accounts application 208 will save the product details (step 930). The saving of the product details includes requesting the product details from the seller (step 934) and receiving the product details from the seller (step 936). Upon saving the product details, accounts application 208 can then save the product profile associated with the product (step 940), discussed in more detail below. The saving of the product profile includes requesting product profile details from the seller (step 944) and receiving the product profile details from the seller (step 946). Once the product profile has been saved, the accounts application 208 will then verify the product as being valid (step 950). If the product is valid, the product becomes published (step 960), or in other words, is made available. Otherwise, the transaction verification server 20 is notified, and asked to handle an exception (step 970). In an exemplary aspect, when the transaction verification server 20 receives notice of an exception, the transaction verification server 20 can prompt the seller to correct, add, or replace incorrect or missing data that led to the exception.

According to an aspect, published products can be available for transactions in the form of goods, services, agreements, rentals, or as a combination of any of those types. Therefore, there is a need for a representation of each possible transaction type for a published good. In an aspect, there can be a separate product profile for each transaction type for a product. The product profile can be configured to limit a type of transaction of a product to specific buyers using account requirements and sales requirements. A sales requirement represents terms and conditions needed to perform the transaction. For example, the sales requirement can include the cost or rental fee of the good, as well as other information. In an example, the sales requirement can include a limit of $5000 coverage in travel insurance for a house rental. Other examples include, but are not limited to, adding a security deposit and having liability insurance for cleaning services, pre-paying for gas for boat rentals.

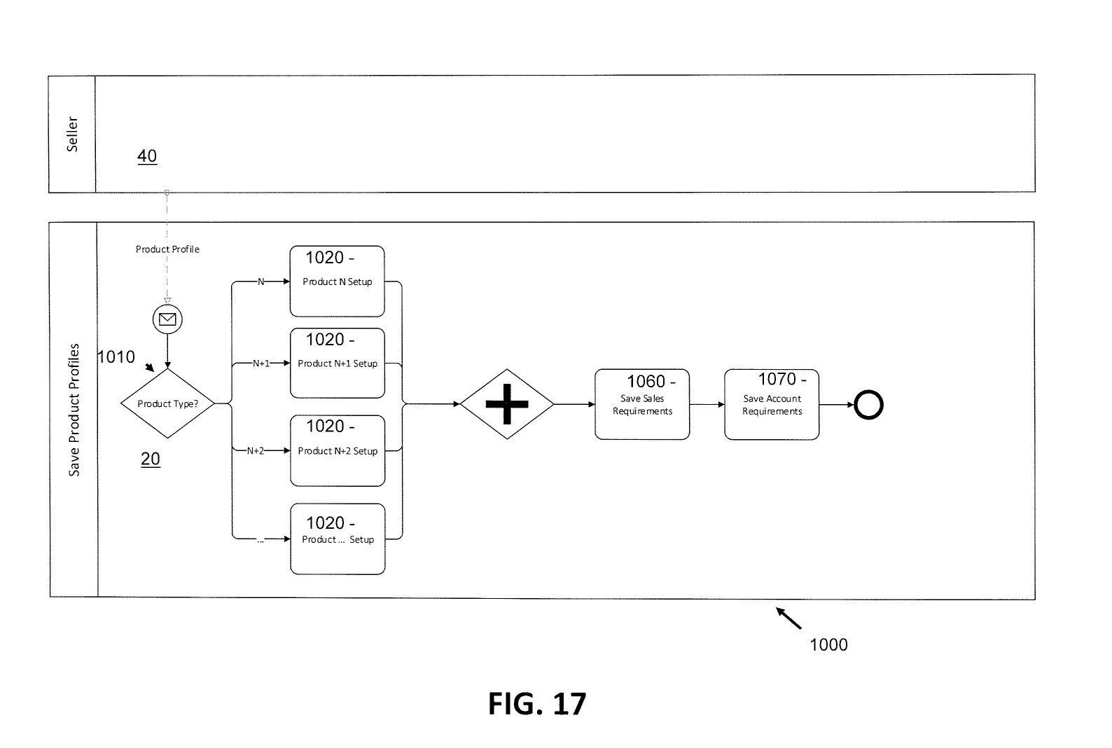

An account requirement requires some knowledge about the buyer, in the form of facts, in order to satisfy the requirement. The account requirements are utilized to find compatible parties to a sale. As stated above, the account requirements are generated and maintained by the seller. If the account requirement is not satisfied by the given facts, or if the facts are not available for the buyer, then the product profile will not be available to the buyer's account. For example, a long term house lease may only be available to a person with a high credit score. FIG. 17 illustrates the setup for a product profile (method 1000) according to an aspect. As shown, the seller can determine the product type (1010), and then select the corresponding product type (step 1020). In an aspect, the selected product type can be the selection of a a rental, a service, an agreement, and or a good. As illustrated in FIG. 17, the seller can have numerous products for sale, with corresponding types associated with the products. Then the seller can then save the sales requirements (1060) and account requirements (1070). FIG. 18 illustrates an example of a data structure for a product according to an aspect. Tables I-III below illustrate examples of account and sales requirements for a seller for a rental vacation home property. As shown below, the requirements can vary based upon the different profile of the renter/buyer.

TABLE I
Friend
Profile: Friend

| | | |
|---|---|---|
| Time | Start Time | Jan. 1, 2014 |
| Availability | End Time | Jan. 1, 2015 |
| Pricing | Unit Price | $5 |
| | Weekly Price | $20 |
| | Monthly Price | $60 |
| | Currency | USD |
| Account | Category | PERSONAL |
| Requirements | SubCategory | FRIEND |
| | Type | EMAIL |
| | String Value | john.doe@example.com |
| | Score | 100 |
| Account | Category | PERSONAL |
| Requirements | SubCategory | FRIEND |
| | Type | EMAIL |
| | String Value | jane.doe@example.com |
| | Required | 100 |
| Account | Category | PERSONAL |
| Requirements | SubCategory | FRIEND |
| | Type | EMAIL |
| | String Value | joe.doe@example.com |
| | Required | 100 |
| Sales | Product ID | (Points to a cleaning |
| Requirements | | service product.) |

TABLE II
Preferred Guest
Profile: Preferred Guest

| | | |
|---|---|---|
| Time | Start Time | Jan. 1, 2014 |
| Availability | End Time | Jan. 1, 2015 |
| Pricing | Unit Price | $120 |
| | Weekly Price | $700 |
| | Monthly Price | $2100 |
| | Currency | USD |
| Account | Category | RENTALHISTORY |
| Requirements | SubCategory | FEEDBACK |
| | Type | FAVORABLESTAYS |
| | Numeric Min | 5 |
| | Score | 100 |
| Sales | Product ID | (Points to a cleaning |
| Requirements | | service product.) |
| Sales | Product ID | (Points to an insurance |
| Requirements | | product.) |

TABLE III
Unknown Guest
Profile: Unknown Guest

| | | |
|---|---|---|
| Time | Start Time | Feb. 1, 2014 |
| Availability | End Time | Nov. 15, 2014 |
| Pricing | Unit Price | $150 |
| | Weekly Price | $1000 |
| | Monthly Price | $3400 |
| | Currency | USD |
| Account | Category | PERSONAL |
| Requirements | SubCategory | CRIMINAL |
| | Type | VERIFICATION |
| | | PASSED |
| | Boolean Value | True |
| | Score | 100 |
| Sales | Product ID | (Points to a cleaning |
| Requirements | | service product.) |
| Sales | Product ID | (Points to an insurance |
| Requirements | | product.) |

As shown above in Tables I-III, the sales requirements and account requirements can vary based upon the level of trust a seller would have with a potential buyer. For example, if the potential buyer is a friend (Table I), the seller can set the account requirements and sales requirements to be fewer in number and require relatively lower thresholds. As shown in Table I, the seller selects account requirements that will identify friends (i.e., the email address of three friends, john doe, jane doe, and joe doe). The friend profile is only requiring one sales requirement for the friend buyer: the friend has to pay for a cleaning service to clean the rental property after use. At this point, the friend can pay for this service at the time the friend secures the rental.

Regarding the preferred guest (Table II), different account requirements and sales requirements can be selected by the seller. As shown in Table II, the account requirement can be based upon the feedback found in the rental history of a buyer. An additional sales requirement to the cleaning service, having travel insurance, is added as well. The unknown guest (Table III) can have a different account requirement than the preferred guest. As shown in Table III, the guest must not have a criminal history. The sales requirements are the same, i.e., having a cleaning service secured and travel insurance.

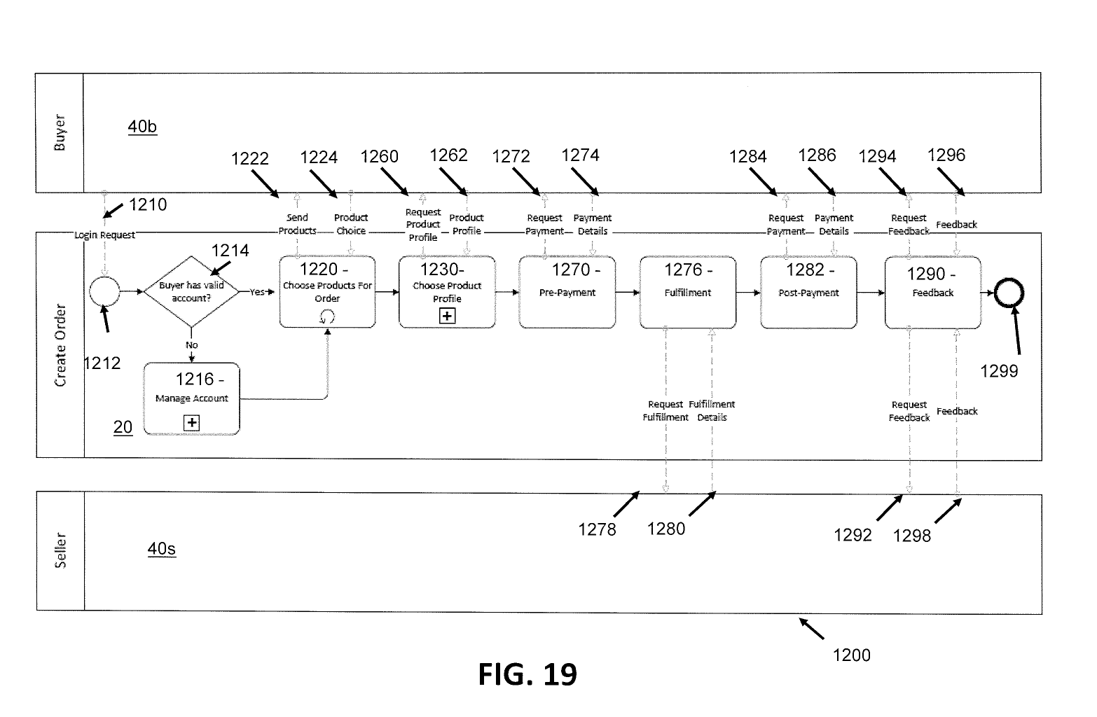

Once the products have been added to the accounts, as well as being associated with the profiles, including all of the sales and account requirements, the products can now be provided to a market place in order to create a transaction. The marketplaces can include, but are not limited to, childcare, pet care, catering, private jet rental, yacht rental, vacation home rental, high value rentals, home service providers, and other markets that benefit from verification. FIG. 19 illustrates a method of creating an order for a buyer (method 1200) according to an aspect of the present invention. In an aspect, steps of the method shown in FIG. 19 can be carried out by a combination of the accounts application 208 and the transaction application 212. First, the transaction verification server 20 receives a login request from a buyer 40b (step 1210). The transaction verification server 20, via the accounts applications 208, can then verify the login information from the user (step 1212). Once verified, the accounts application 208 can see if the buyer 40b has a valid account (step 1214). If not, the accounts application 208 can have the buyer 40b go through the manage account process (step 1216), as discussed above.

If the buyer 40b does have a valid account (step 1214), or has set up a valid account (step 1216), the accounts application 208 can then allow the buyer 40b to choose a product or products for order (step 1220). The combination of the accounts application 208 and the transaction application 212 can provide the available products to the buyer 40b (step 1222). The transaction verification server 20 can then receive the selected products from the buyer 40b (step 1224). Once the product selections have been received, the transaction verification server 20 will then determine the available product profiles from which the buyer 40b can choose (step 1230), discussed in more detail below, and present such profiles to the buyer 40b (step 1260). In an aspect, if the products require more information that is not currently available, the transaction application 212 can make a statistical guess as to whether this fact is most likely going to work out. For example, most people are not criminals, so the transaction verification server 20 may show all the profiles for vacation homes that require a criminal background check even if the server 20 cannot confirm the buyer is not a criminal. In such aspects, the server 20 can be configured to inform the buyer that the availability and pricing is contingent on a successful criminal verification check (i.e., acquiring the information from a fact provider 30) or something similar.

The transaction verification server 20 can then receive the selected profile from the buyer 40b (step 1262). Once the profile has been received, the transaction application 212 can then proceed to prepare the pre-payment for the selected product and profile (step 1270), which includes requesting the payment from the buyer 40b (step 1272) and receiving the payment details from the buyer (step 1274). Once the payment details have been received, the transaction application can then begin the fulfillment of the order (step 1276), including requesting fulfillment from the seller 402 (step 1278) and receiving fulfillment details from the seller 40s (step 1280). The fulfillment steps (1278 and 1280) are the acquiring of actions, confirmation, and information needed to carry out the transaction.

Once the fulfillment details have been received, the transaction application can turn to post-payment (step 1282), which include requesting payment from (step 1284) and receiving payment from (step 1286) the buyer. After the post-payment has been completed, the transaction verification server 20 can request feedback from the buyer 40b (step 1290), which includes receiving a feedback request from the seller 40s (step 1292), sending the feedback request to the buyer 40b (step 1294), receiving the feedback from the buyer 40b (step 1296), and sending the feedback to the seller 40s (step 1298). Once the feedback has been provided, the transaction is completed (step 1299).

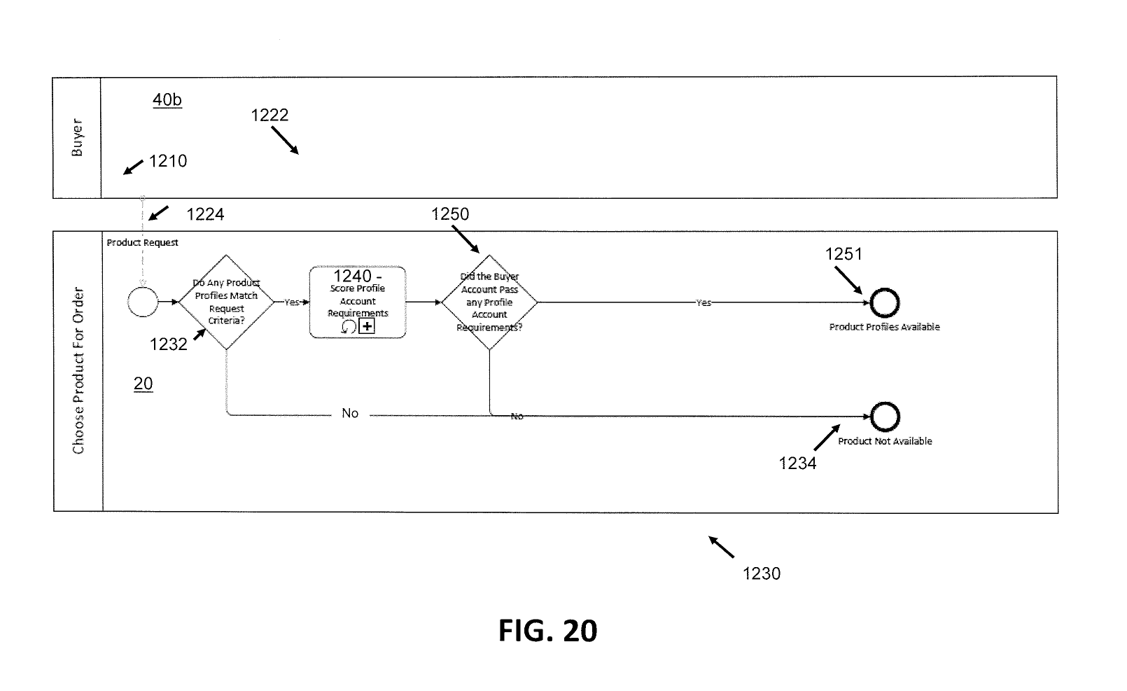

FIG. 20 illustrates how the accounts application 208/transaction application 212 determine which profiles are available for a buyer 40b after a product has been selected (step 1230) according to an aspect. The accounts profile will first look to see if the product profiles are available for the product (step 1232). If there are no profiles available, the accounts application 208/transaction application 212 will provide notice to the buyer 40b that the product is not available (step 1234). If there are profiles available, the accounts application 208/transaction application 212 can score the profile account requirements against the buyer facts to determine what profiles are available for the buyer to select (step 1240), discussed in more detail below. In an exemplary aspect, the scoring can be based upon the selected restriction preferences (i.e., the factoring aspect) (606a) as discussed above. Once the scoring has been done, the transaction application 212 will determine if the facts of the buyer pass the profile account requirements (step 1250). If the buyer has facts that pass the requirements for any of the profiles of the product, then the product profiles are provided to the buyer 40b if the profile meets the buyer's sale requirements (step 1251). Otherwise, if no profiles are available, the buyer 40b is notified that the product is not available (step 1234).

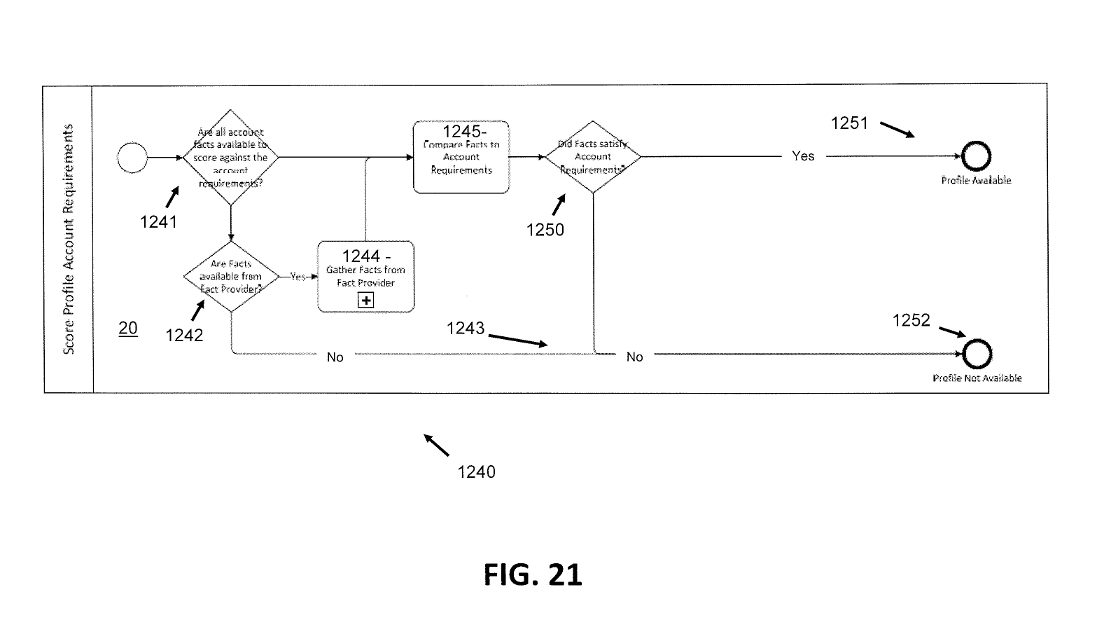

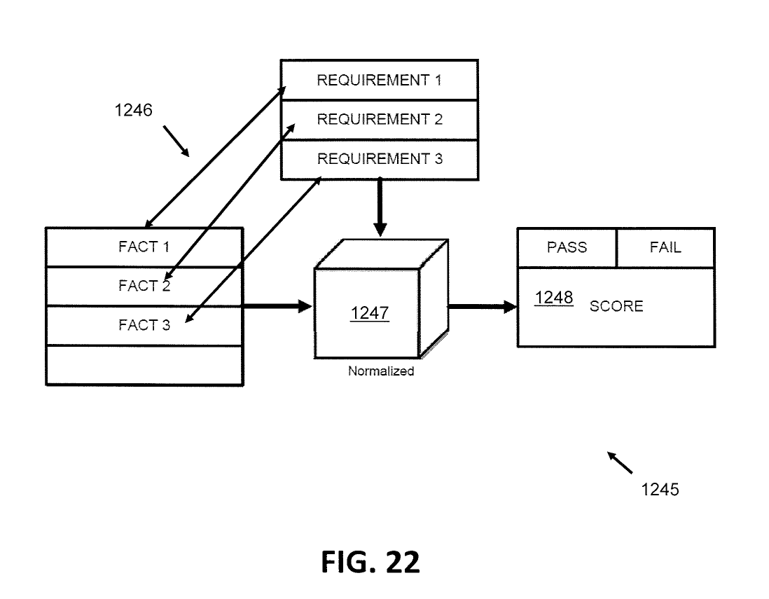

FIGS. 21-22 illustrates a scoring method (step 1240) discussed above according to an aspect. First, the accounts application 208 will determine if all account facts are available to score against the account requirements of a profile (step 1241). If not all facts are available, the accounts application 208 will determine if the facts are available from a fact provider 30 (step 1242). If the facts are not available from fact providers, the accounts application 208 will report that the profile is not available (step 1243). If the facts are available, the facts will be gathered (step 1244). Once the facts needed have been collected (either they are available after step 1241 or step 1244), the facts are compared against the account requirements (step 1245), as shown in more detail in FIG. 22 according to an aspect.

As shown in FIG. 22, each of the facts is then compared against a corresponding requirement type (step 1246). In the example shown in FIG. 22, three facts (FACT 1, FACT 2, FACT 3) are compared respectively to three requirements (REQUIREMENT 1, REQUIREMENT 2, REQUIREMENT 3). The comparison then generates a score (step 1248). For example, a product profile may be configured to have a score or threshold of 100 in order for the product to be available to a buyer. In an aspect, the scores can be normalizes (step 1247) before being finalized (step 1248). The score can be generated by meeting certain account requirements, wherein having the account requirements generates a number of points. For example, being a friend of the seller gets 100 points, passing a criminal background check generates 50 points, having a stay history with 10 positive stays generates 100 points, 5 positive stays generates 50 points, etc. In this example, it is possible for buyers that meet some, but not all, of the requirements to pass the score threshold. In the example discussed above, a buyer who is not a friend, but who passes a criminal background check (50 points) and has 6 positive stays (60 points), passes the threshold (50+60=110) of 100. In an aspect, the score can then be normalized before producing the score. The score then can be compared to see if it satisfies all the account requirements (step 1250) as shown in FIG. 21. If the facts/score are satisfactory, the profile can be presented (step 1251). Otherwise, the profile is reported as being unavailable (step 1252). This process can be repeated for all of the profiles associated with the good.

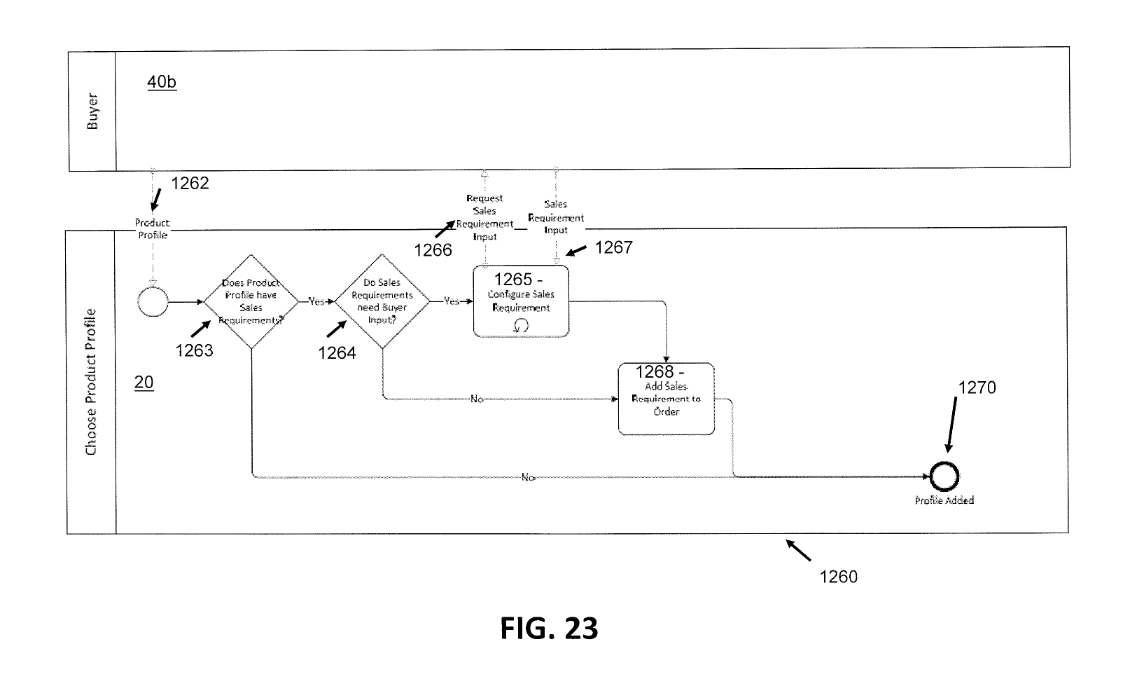

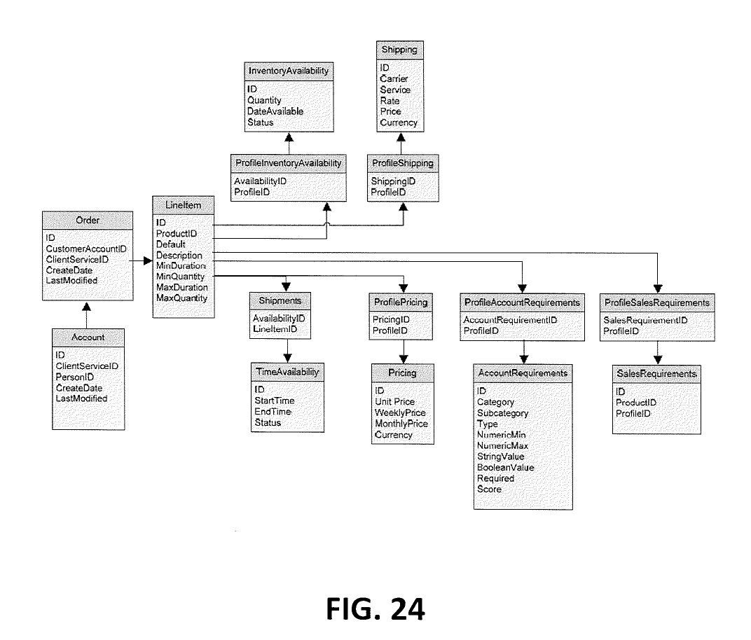

Once the product profiles have been identified for which the buyer has met the requirements, the account application 208 can provide the profiles to the buyer (step 1260), as shown in FIG. 23. Once a profile has been selected (step 1262), the combination of the accounts application 208 and transaction application 212 can then determine the sales requirements that need to be added to the order, as illustrated in FIG. 23. The accounts application will determine whether or not the product profile has sales requirements (step 1263). If no sales requirements are needed, the profile is added and then goes onto pre-payment (step 1270). If sales requirements are needed, the accounts application 208 determines if the sales requirements need buyer input (step 1264). The accounts application 208 can review the accounts of the buyer to see if buyer input is needed. If needed, the sales requirements are configured (step 1265), which can include generating and sending a request for input to the buyer 40b (step 1266) and receiving the sales input requested (step 1267). Once the requirements are known (either from review of the configuration), the sales requirements are added to the order (step 1268) and then passed along to the pre-payment step 1270. FIG. 24 illustrates a data structure for an order. In an aspect, the order will be generated based upon standard industry practices.

In an exemplary aspect, a sales requirement can include funds to be placed in escrow before the completion of a transaction between the seller and the buyer. A seller can make such a sales requirement when the seller faces a greater risk of being a victim of fraud, even after account requirements have been compared. In such instances, the seller can configure the transaction to require greater funds from the transaction to be kept in escrow until the end of the transaction. In some instances of this exemplary aspect, some funds can be delivered to the seller before the end of the transaction.

In another aspect, the fulfillment of the payment terms by the buyer can be based upon a various factors. One factor can be the amount for the product. For example, if the product cost is relatively low, there can be no restrictions of the payment terms, requiring the buyer to pay the seller at the completion of the transaction. If the product cost is a significant amount, the payment terms can be set to have the buyer pay a partial amount to the seller at the completion of the transaction and the balance once the product has been delivered, or in the case of as service, one the service has been completed. In some instances, the payment terms can be set to have the buyer pay the full amount at the delivery/completion of the product. Another factor can be the transaction history of the seller, such as the number of satisfactory transactions between the compatible seller and other buyers, or the compatible buyer him/herself. For example, if the seller has reached a certain thresholds of favorable transactions, the payment terms can require all or partial payment for the product at the completion of the transaction. In an exemplary aspect, the fulfillment of payment terms by the buyer can be based upon the combination of price of the product as well as the transaction history between the buyer and the seller. For example, the price of the product can dictate how many satisfactory transactions must have been completed between the buyer and seller for the payment to be (1) done at the delivery/completion of the product, (2) split between the completion of the transaction and the delivery/completion of the product, and (3) at the completion of the transaction. Table IV below illustrates payment fulfillment requirements according to one example.

| Price of Product | Number of Satisfactory Transactions (ST) = |
|---|---|
| (PP) | Payment Terms |
| 0 < PP ≦ $100 | No restrictions (pay at completion of transaction) |
| $100 < PP ≦ $500 | If ST <_20, then 100% delivered upon delivery/ |
| | completetion of product; |
| | If 20 ≦ ST < 50, then 50% delivered at completion |
| | of transaction, 50% delivered at delivery/completion |
| | of product; |
| | If 50 < ST, then 100% delivered at completion of |
| | transaction |
| 500 < PP ≦ $3000 | If ST <_80, then 100% delivered upon delivery/ |
| | completion of product; |
| | If 80 ≦ ST < 200, then 50% delivered at completion |
| | of transaction, 50% delivered at delivery/completion |
| | of product; |
| | If 200 ≦ ST, then 100% delivered at completion of |
| | transaction |

The factors determining the payment terms can be determined by the buyer when the buyer is setting up the buyer account. The factors can be based upon the region, business unit, and the like of the buyer. In another aspect, the factors can be selected by an administrator.

Having thus described exemplary embodiments of the present invention, those skilled in the art will appreciate that the within disclosures are exemplary only and that various other alternatives, adaptations, and modifications may be made within the scope of the present invention. Accordingly, the present invention is not limited to the specific embodiments as illustrated herein, but is only limited by the following claims.

What is claimed is:

1) A transaction verification system configured to facilitate the buying and selling of products between a plurality of compatible buyers and sellers, the transaction verification system comprising:
a) a transaction verification server configured to communicate with a plurality of network devices and a plurality of fact providers, wherein the plurality of network devices are associated with the plurality of compatible buyers and sellers, wherein the transaction verification server is configured to:
i) manage accounts associated with the plurality of compatible buyers and sellers;
ii) verify information provided by the plurality of the compatible buyers and sellers for the accounts; and
iii) facilitate transactions between the compatible buyers and sellers based upon the verified information and settings of the accounts of the compatible buyers and sellers.

2) The transaction verification system of claim 1, wherein the transaction verification server is configured to facilitate transactions between the plurality of compatible buyers and sellers by
a) verifying a buyer has a valid account;
b) allowing the buyer to choose a product;
c) scoring the buyer against product profiles of individual products associated with the chosen product to determine available products for the buyer;
d) providing the available products to the buyer; and
e) receiving the selection from the available products from the buyer.

3) The transaction verification system of claim 1, wherein scoring the buyer against the product provides of individual products associated with the product comprises:
i) comparing facts of the buyer to the account requirements of the product profiles;
ii) generating a score from the comparison of the facts to the account requirements;
iii) and grouping the individual product into the available products when the score is greater than a threshold.

4) The transaction verification of claim 2, wherein the transaction verification server is further configured to facilitate transactions by having the buyer agreeing to fulfill a sales requirement associated with the product profile of the selection from the available products before initiating the transaction.

5) The transaction verification of claim 4, wherein the sales requirement further requires funds from the seller to be placed in escrow before initiating the transaction.

6) The transaction verification system of claim 1, wherein the transaction verification server is configured to verify information provided by the plurality of the compatible buyers and sellers for the accounts by:
a) identifying fact categories needed to be verified;
b) requesting from the plurality of fact providers information corresponding to the fact categories;
c) receiving from the plurality of fact providers the corresponding information; and
d) comparing the corresponding information to user supplied information corresponding the fact categories for verification.

7) The transaction verification system of claim 6, wherein after the comparison of the corresponding information to the user supplied information does not result in verification, the transaction verification server terminates the account associated with the user supplied information.

8) The transaction verification system of claim 6, wherein after the comparison of the corresponding information to the user supplied information does not result in verification, the transaction verification server prompts a user associated with the user supplied information to correct the user supplied information.

9) The transaction verification system of claim 6, wherein the transaction verification server is configured to verify information by identifying additional fact categories and requesting from the plurality of fact providers additional information corresponding to the additional fact categories after the comparison of the corresponding information to the user supplied information does result in verification.

10) The transaction verification system of claim 1, wherein the transaction verification server is configured to manage accounts associated with the plurality of compatible buyers and sellers by generating and maintaining profiles and records for the plurality of the compatible buyers and sellers, wherein the profiles and the records are associated with accounts of the compatible buyers and sellers.

11) The transaction verification system of claim 10, wherein the records comprise a person record, wherein the person record is configured to be associated with one individual and can be configured to can be associated with several different accounts.

12) The transaction verification system of claim 10, wherein the profiles can comprise seller profiles, buyer profiles, and product profiles.

13) The transaction verification system of claim 12, wherein the seller profiles can comprise buyer requirements and the buyer profiles can comprise seller requirements.

14) The transaction verification system of claim 13, wherein the product profiles are configured to comprise account requirements and sales requirements.
